(19) United States
(12) Patent Application Publication
(10) Pub. No.: US 2009/0060681 A1
(43) Pub. Date: Mar. 5, 2009

(54) ANCHOR CLIP

(75) Inventor: Hideaki NAKANISHI, Toyohashi-shi (JP)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/196,874

(22) Filed: Aug. 22, 2008

(30) Foreign Application Priority Data
Aug. 30, 2007 (JP) 2007-224011

(51) Int. Cl. F16B 21/08

(52) U.S. Cl. 411/509

(57) ABSTRACT

A clip including a flange, a shank extending longitudinally from the flange and at least one leg extending from an end of the shank towards the flange. The at least one leg comprises a root portion where the leg meets the shank, an adjacent portion adjacent to the root, a bridge portion connecting the root and the adjacent portion and an extending portion extending from the adjacent portion towards the flange and the extending portion has a linear outer shape.

### CROSS-REFERENCE TO RELATED APPLICATIONS

This application claims the benefit of Japanese Application No. 2007-224011, filed Aug. 30, 2007. The disclosure of the above application is incorporated herein by reference.

### BACKGROUND OF THE INVENTION

1. Technical Field

The present invention relates to an anchor clip that has a flange, a shank descending straight down from the flange, and a plurality of legs extending from the tip portion of the shank toward the flange so as to separate from the shank.

2. Background Art

Clips which have a flange, a shank descending straight down from the flange, and a plurality of legs extending from the tip portion of the shank toward the flange so as to separate from the shank, are well known. Such an anchor clip is attached to a member being attached to by inserting the shank and the legs into an attachment hole in a member being attached to, causing latching ends at the tips of the legs to latch on the edge of the attachment hole, and clamping the member being attached to between the legs and the flange. Such anchor clips are described in Patent Literature 1 to 3.

Patent Literature 1: JIKKAI [Unexamined Util. Mod. Appln.] No. S55-120817/1980 (Gazette)

Patent Literature 2: TOKKO [Examined Pat. Appln. Pub.] No. S55-037646/1980 (Gazette)

Patent Literature 3: TOKKAI [Unexamined Pat. Appln. Pub.] No. 2006-292118 (Gazette)

The anchor clip in Patent Literature 1 has a pair of legs, formed in plate shapes of substantially the same wide width as a plate-shaped shank, with the shank therebetween. Accordingly, in order to definitely attach this clip to a member being attached to, the attachment hole must be a rectangular hole having a wide width corresponding to those wide-width legs, making the clip unsuitable for being stably attached in a round hole. The anchor clip in Patent Literature 2 is suitable for a round hole, but, because latching rods extending in the lateral direction are provided at the tips of the legs, a hole large enough to admit those latching rods is necessary, making the clip unsuitable for being stably attached in a small round hole.

The anchor clip described in Patent Literature 3 has a flange, a shank descending straight down from the flange, and a pair of legs extending from the tip portion of the shank toward the flange so as to separate from the shank, and each of the legs is formed in a narrow plate shape. Accordingly, the clip can be stably attached to a member being attached to, so long as the attachment hole of the member being attached to will admit the narrow plate-shaped legs, even if the attachment hole is a round hole that is smaller than the clips of Patent Literature 1 or 2. However, in current (conventional) anchor clips, including this anchor clip of Patent Literature 3, when a force acts on the shank so as to pull out the clip, because the legs are formed in narrow plate shapes, the legs undergo flex deformation, and there is a danger that the latching ends of the leg tips will disengage from the edge of the attachment hole and that the clip will be pulled out from the member being attached to.

Referring to FIG. 1 and FIG. 2, the problems with a current (conventional) anchor clip are described. In FIG. 1, a conventional anchor clip 1 is integrally formed of a hard plastic, and has a flange 2, a shank 3 descending straight down from the flange 2, and a pair of legs 5 extending from the tip portion of the shank 3 toward the flange 2 so as to separate from the shank 3. Each leg 5 has, at the tip thereof, a latching end 6, formed in a plate shape of a substantially constant thickness in the radial direction, for latching on the edge of an attachment hole in a member being attached to. As diagrammed in FIG. 2, the shank 3 and legs 5 are inserted into the attachment hole of the member being attached to 7, the latching ends 6 at the tips of the legs 5 are latched onto the edge of the attachment hole, and the member being attached to 7 is clamped between the legs 5 and the flange 2. Thereby, the anchor clip 1 is attached to the member being attached to 7. In FIG. 2, when a pulling-out force acts on the anchor clip 1 in the direction of the arrow 9, the legs 5, because they are formed in narrow plate shapes of constant thickness, undergo flex deformation, as indicated by the circle X and the circle Y. That flex deformation occurs throughout the entirety of the legs 5, being slightly greater in the root portion of the legs indicated by the circle Y, and also slightly greater in the vicinity of the latching ends 6. Due to this flex deformation, there is a danger of the anchor clip 1 being pulled completely away from the member being attached to 7.

Accordingly, an object of the present invention is to provide an anchor clip, wherein the legs are formed in narrow plate shapes, wherewith there is no danger of the clip being pulled away, even if subjected to a pulling-out force.

### SUMMARY OF THE INVENTION

In order to achieve one aspect of the invention, an anchor clip based on an exemplary embodiment of the present invention has a flange, a shank descending straight down from that flange, and a plurality of legs extending from the tip portion of that shank toward the flange so as to separate from the shank, configured such that each leg is formed in a narrow plate shape, such that a member being attached to is attached to by inserting the shank and the legs into an attachment hole in the member being attached to, causing latching ends at the tips of the legs to latch on the edge of the attachment hole, and clamping the member being attached to between the legs and the flange, wherein each of the legs has the portion thereof extending, from an adjacent portion that is adjacent to the root portion at the shank tip portion, to the latching end for latching the edge of the attachment hole, formed in a linear outer shape, and that leg portion of the linear outer shape, in the adjacent portion, is formed such that the thickness thereof in the radial direction is thinner than the other portions thereof, such that, when a force is applied to the clip attached to the member being attached to so as to pull the clip from the flange end, the legs maintain high latching forces, resisting the pulling force, with the flex deformation thereof concentrated in the adjacent portions of the legs, and the leg portions having the linear outer shapes from the adjacent portions to the latching ends exhibiting no flex deformation.

By the configuration described above, even though the legs be formed in narrow plate shapes, when acted on by a pulling-out force, the legs will maintain a high latching force, resisting any pulling-out force, with the flex deformation occurring therein concentrated between the root portions of the legs and the adjacent portions that are adjacent to the root portions, and the leg portions of linear outer shape from the root portions to the latching ends not undergoing flex deformation, wherefore there is no danger of the clip being pulled away.

In the clip described above, the portions between the root portions of the legs and the adjacent portions adjacent to the root portions are formed as bridges for connecting the legs and the shank, the length of each of which bridges is formed shorter than the length between the root portion of one leg and the root portion of another leg at the tip portion of the shank, in a configuration wherein the flex deformation of the legs is concentrated in the short bridges. In each leg, the portion from the adjacent portion to the latching end is formed so that the thickness in the radial direction gradually increases toward the latching end. The legs are provided in a pair, opposing each other with the shank therebetween, the shank is formed in a plate shape having a width that widens in a perpendicular dimension in the lateral cross-section thereof, between the pair of legs, and, in the shank, a cut-away portion which extends in the axial direction is formed on both sides of the width dimension. In the flange, a pipe holder is integrally formed at the end opposite the shank.

### BRIEF DESCRIPTION OF THE DRAWINGS

FIG. 1 is a front elevation of the main portion of a conventional anchor clip.

FIG. 2 is a front elevation of the conventional anchor clip of FIG. 1 when it is attached to a member being attached to and subjected to a pulling-out force.

FIG. 3 is an overall front elevation of an anchor clip relating to one embodiment of the present invention.

FIG. 4 is a front elevation of the main portion, being the portion within the enclosure line A of the clip diagrammed in FIG. 3, of an anchor clip relating to one embodiment of the present invention.

FIG. 5 is a section at the B-B line of the clip diagrammed in FIG. 4.

FIG. 6 is a front elevation of the anchor clip diagrammed in FIG. 4, relating to one embodiment of the present invention, when attached to a member being attached to.

FIG. 7 is a front elevation diagramming how the clip of FIG. 6 is subjected to a pulling-out force.

### DETAILED DESCRIPTION OF EXEMPLARY EMBODIMENTS OF THE PRESENT INVENTION

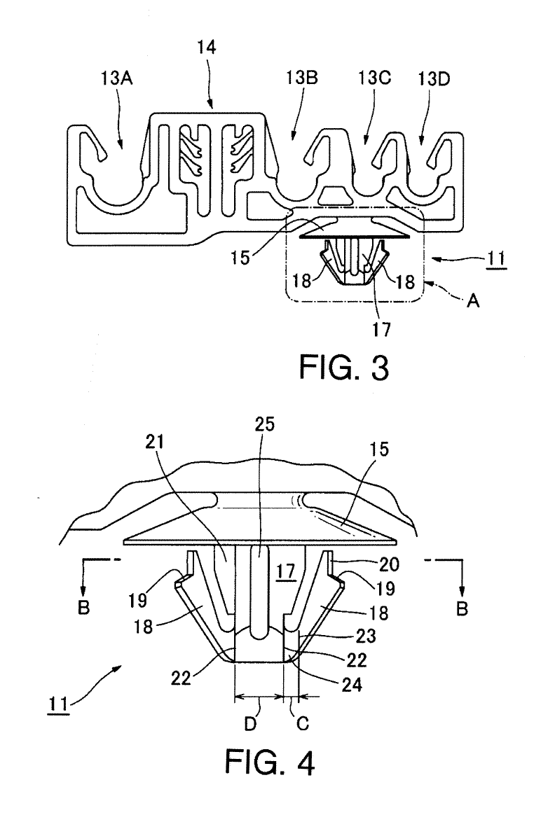

An anchor clip 11 made of hard plastic and relating to one exemplary embodiment of the present invention is now described with reference to FIGS. 3 to 7. In FIG. 3, in the anchor clip 11, a plurality of pipe holders 13A to 13D is integrally formed, and, between pipe holders 13A and 13B, a stud securing part 14, for latching to a rod-shaped stud such as a screw stud, is integrally formed. With the anchor clip 11, relating to one embodiment of the present invention, for example, by securing the stud securing part 14 to a rod-shaped stud erected on a vehicle body panel, a plurality of pipes such as brake fluid pipes or fuel pipes, held in the pipe holders 13A to 13D, can be attached to the body panel. Also, in the clip 11 the main portion whereof is the portion enclosed by the enclosing line A in FIG. 3, a cover for covering a plurality of pipes can be attached as the member being attached to, whereupon the pipes or the like are covered by the cover and protected.

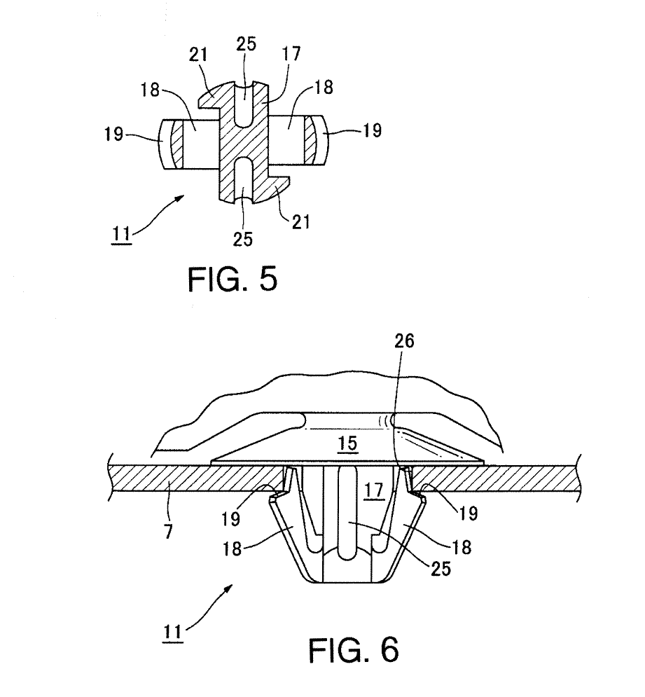

FIG. 4 diagrams the main portion of the anchor clip 11 relating to one exemplary embodiment of the present invention that is enclosed by the enclosing line A in FIG. 3. The clip 11 has a flange 15, a shank 17 descending straight down from the flange 15, and a pair of legs 18 extending from the tip portion (the lower end portion in FIG. 4) of the shank 17 toward the flange 15 so as to separate from the shank 17. The legs 18 are provided in an opposing pair, with the shank 17 in between, as diagrammed in FIG. 5, which is a section at the B-B line in FIG. 4. The number of legs 18 is two in the example diagrammed, moreover, but may be 3 or more. Each leg 18 is formed in a narrow plate shape that extends from the tip portion of the shank 17 (the lower end portion in FIG. 4) toward the flange 15 so as to separate from the shank 17. At the tips of the legs 18, latching ends 19, for latching on the edge of a attachment hole in a member being attached to, are formed. At the tops of the latching ends 19, stoppers 20, for abutting the side wall surfaces of the attachment hole and preventing the disengagement of the latching ends 19, are formed. As diagrammed in FIG. 5, the shank 17 is formed in a plate shape, having a width that widens (or extends) in a perpendicular direction, in the lateral cross-section thereof, with the pair of legs 18 in between. In the shank 17, furthermore, at the edges on both sides of the portion adjacent to the flange 15, guides 21 are formed which extend in the circumferential direction so as to make contact along the side edge of the attachment hole of the member being attached to, for stabilizing the clip when the shank 17 has been inserted into the attachment hole.

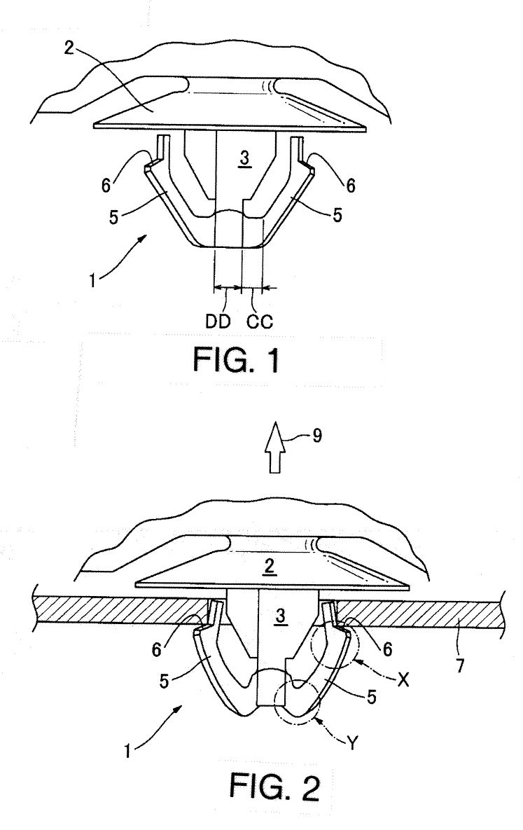

In each leg 18, the portion from the adjacent portion 23 adjacent to the root portion 22 at the tip portion of the shank 17 to the latching end 19 is formed so as to extend in a linear outer shape (an outer shape formed by a linear outline) in the longitudinal direction. The leg portion from the adjacent portion 23 to the latching end 19, moreover, is formed so that the thickness thereof gradually becomes greater in the radial direction toward the latching end 19. The leg portion between the root portion 22 and the adjacent portion 23 of each leg 18 constitutes a bridge 24 that connects the leg 18 to the shank 17. In the legs 5 of the conventional anchor clip 1 diagrammed in FIG. 1, the portions from the portions adjacent to the root portions to the latching ends 6 do not constitute linear outer shapes, but rather non-linear, slightly curved outer shapes, and the thickness thereof in the radial direction thereof is formed to be substantially constant. However, the leg portion of the linear outer shape of each of the legs 18 in the anchor clip 11 relating to the exemplary embodiment of the present invention (that is, the portion from the adjacent portion 23 to the latching end 19) is formed so that the thickness thereof in the radial direction in the adjacent portion 23 is thinner than the other portions, whereupon almost all of the flex deformation observed in the bent legs 5 of constant thickness of the conventional anchor clip 1 diagrammed in FIG. 1 disappears. Furthermore, that leg portion 18 of the linear outer shape is formed so that the thickness thereof gradually increases in the radial direction toward the latching end 19, and, thereby, the flex deformation disappears even more. In other words, in the anchor clip 11 attached to a member being attached to, when a pulling-out force acts, from the flange 15 end, on the legs 18, the flex deformation therein all but does not occur, in the leg portions from the adjacent portions 23 to the latching ends 19. As a consequence, the leg portions from the root portions to the latching ends do not exhibit flex deformation, but maintain a high latching force, resisting any pulling-out force. In addition, the force causing the flex deformation is concentrated in the bridges 24 between the root portions 22 of the legs 18 and the adjacent portions 23 adjacent to the root portions 22.

In the anchor clip 11 relating to the exemplary embodiment of the present invention, the length C (FIG. 4) of the bridge 24 between the root portion 22 of each leg 18 and the adjacent portion 23 adjacent to the root portion 22 is formed at a length that is shorter than the length D (FIG. 4) between the root portion 22 of one leg 18, at the tip portion of the shank 17, and the root portion 22 of another leg 18. Contrasting therewith, in the conventional clip 1, as diagrammed in FIG. 1, the length CC between the root portion of each leg 5 and the adjacent portion is substantially the same length as the length DD between the root portion of one leg 5, at the tip portion of the shank 3, and the root portion of another leg 5, and is not short as is the length C in the present invention. As described above, the length C of the bridge 24 between the root portion 22 and the adjacent portion 23 of each leg 18 is formed short, while, on the other hand, there is almost no flex deformation in the leg portion of linear outer shape from the adjacent portion 23 to the latching end 19. Therefore, when the legs 5 are inserted into the attachment hole of a member being attached to, the legs 18 are bent at the short bridges 24 between the root portions 22 and the adjacent portions 23. These bridges 24 function as articulating portions, making it easy for the legs 18 to topple over toward the sides of the shank 17 when being inserted, the force of resistance when inserting the shank 17 and the legs 18 into the attachment hole becomes smaller, and the insertion force can be lessened.

As diagrammed in FIG. 4 and FIG. 5, in the shank 17, cut-away portions 25 are formed, at both sides thereof in the width dimension, extending in the axial direction. Thereby, the material used in the anchor clip 11 can be saved and the weight thereof lightened. The cut-away portions 25, moreover, prevent sinking-in during molding and make the material thickness uniform.

How the anchor clip 11 formed in the configuration described above is attached to a member being attached to 7 is diagrammed in FIG. 6. The shank 17 and legs 18 of the anchor clip 1 1 are inserted into the attachment hole 26 of the member being attached to 7, the flange 15 comes up against the member being attached to 7, and the clip is pushed in until the latching ends 19 of the legs 18 latch on the edge of the attachment hole 26. As to the force of insertion at that time, leg portions from the adjacent portions 23 to the latching ends 19 are formed in linear outer shapes, the thickness in the radial direction of the portions in the adjacent portions 23 is formed thinner than the other leg portions of linear outer shape, and the bridges 24 operate as joints, wherefore the force of resistance during insertion is diminished, and the insertion force can be lessened. By that insertion, the member being attached to 7 is clamped between the latching ends 19 of the legs 18 and the flange 15, whereupon the anchor clip 11 is attached to the member being attached to 7.

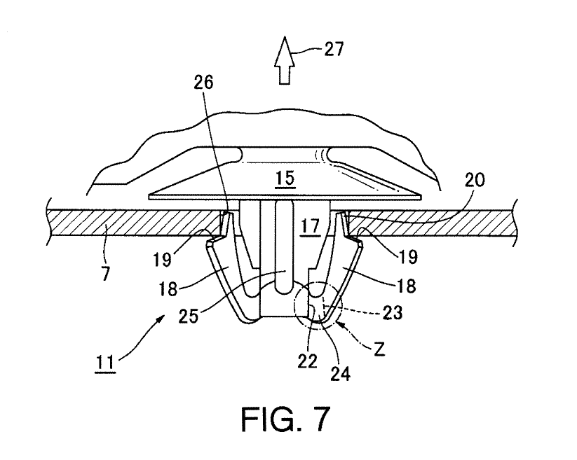

With the anchor clip 11 having been attached to the member being attached to 7, consider the case of a pulling-out force acting on the anchor clip 11, as indicated by the arrow 27 in FIG. 7. The pulling-out force is transmitted to the shank 17, then transmitted from the shank 17 to the legs 18, becoming a force causing the latching ends 19 to press against the member being attached to 7. As already described, the leg portions from the adjacent portions 23 to the latching ends 19 are formed as linear outer shaped portions, and, in addition, are formed so that the thickness thereof gradually increases toward the latching ends 19. As a consequence, the linear outer shaped portions of the legs 18 of the anchor clip 11 relating to the exemplary embodiment of the present invention are subjected to almost no flex deformation, unlike the case when the legs are bent as in a conventional clip. In other words, when a pulling-out force is applied to the anchor clip 11 attached to the member being attached to, from the flange 15 end, the flex deformation acting on the legs 18 hardly occurs at all in the leg portions from the adjacent portions 23 to the latching ends 19. Accordingly, the legs 18 maintain a high latching force, resisting the pulling-out force, and, consequently, so long as the legs 18 do not break, there is no danger of the anchor clip 11 being pulled away. Moreover, the forces acting to cause flex deformation in the legs 18 are concentrated in the bridges 24 between the root portions 22 and the adjacent portions 23 of the legs 18, but, because those bridge 24 portions are formed very short, the flex deformation is small, as indicated by the round Z area in FIG. 7, which is another reason why the danger of the anchor clip 11 being pulled away is done away with.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A clip comprising:
a flange;
a shank extending longitudinally from the flange;
at least one leg extending from an end of the shank towards the flange;
wherein the at least one leg comprises a root portion where the leg meets the shank, an adjacent portion adjacent to the root, a bridge portion connecting the root and the adjacent portion and an extending portion extending from the adjacent portion towards the flange;
wherein the extending portion has a linear outer shape.

2. The clip according to claim 1, wherein a radial width of the adjacent portion is smaller than a radial width of the root portion.

3. The clip according to claim 2, wherein the radial width of the adjacent portion is smaller than a radial width of the extending portion.

4. The clip according to claim 1, wherein a radial width of the extending portion increases in a direction away from the adjacent portion.

5. The clip according to claim 1, wherein the at least one leg comprises a latching end at the end of the extending portion.

6. The clip according to claim 5, wherein a radial width of the extending portion increases from the adjacent portion to the latching end.

7. The clip according to claim 1, wherein the at least one leg comprises a pair of opposing legs and wherein the shank is disposed between the pair of opposing legs.

8. The clip according to claim 7, wherein a pair of cutaway portions are formed on opposite sides of the shank.

9. A clip comprising:
a flange;
a shank extending longitudinally from the flange;
at least one leg extending from an end of the shank towards the flange;
wherein the at least one leg comprises a root portion where the leg meets the shank, an adjacent portion adjacent to the root, a bridge portion connecting the root and the adjacent portion and an extending portion extending from the adjacent portion towards the flange;
wherein a radial width of the extending portion increases in a direction away from the adjacent portion.

10. The clip according to claim 9, wherein the at least one leg comprises a latching end at the end of the extending portion and wherein the radial width of the extending portion increases from the adjacent portion to the latching end.

11. An anchor clip comprising:
a flange,
a shank descending straight down from the flange, and
a plurality of legs extending from a tip portion of the shank toward said flange so as to separate from said shank;
wherein each leg is formed in a narrow plate shape, such that a member being attached to is attached to by inserting said shank and said legs into an attachment hole in the member being attached to, causing latching ends at the tips of said legs to latch on an edge of said attachment hole, and clamping said member being attached to between the legs and said flange; and
wherein said legs comprise a root portion at said shank tip portion, an adjacent portion adjacent to the root portion and an extending portion extending from the adjacent portion to the latching end for latching the edge of said attachment hole;
wherein the extending portion is formed in a linear outer shape; and
wherein the thickness of the adjacent portion in the radial direction is thinner than the thickness of the root and extending portions; and
wherein when a force is applied to the anchor clip attached to said member being attached to so as to pull the anchor clip from said flange end, said legs maintain high latching forces, resisting said pulling force, with the flex deformation thereof concentrated in said adjacent portions of said legs, and the leg portions having said linear outer shapes from said adjacent portions to said latching ends exhibit no flex deformation.

12. The clip according to claim 11, wherein each leg comprises a bridge portion between said root portion and said adjacent portion, the bridge portion connecting the leg to said shank;
wherein the bridge portion is shorter than a length between the root portion of one of the plurality of legs and the root portion of another of the plurality of legs in said tip portion of said shank, and said flex deformation in said legs is concentrated in the bridge portion.

13. The clip according to claim 11, wherein, in each of said legs, the thickness of the extending portion in the radial direction gradually increases from the adjacent portion to said latching end.

14. The clip according to claim 11, wherein the plurality of legs comprises a pair of opposing legs and said shank is disposed between the pair of opposing legs;
wherein said shank is formed in a plate shape and has a width that widens in a perpendicular dimension in the lateral cross-section of the shank between the pair of legs; and
wherein a cut-away portion which extends in the axial direction is formed on both sides of the shank in said width dimension.

15. The clip according to claim 11, wherein a pipe holder is integrally formed in said flange at an end opposite said shank.
